(19) United States
(12) Patent Application Publication
(10) Pub. No.: US 2002/0147681 A1
(43) Pub. Date: Oct. 10, 2002

(54) Method of and apparatus for building management, and program product

(75) Inventors: Hiroshi Taninaka, Hyogo (JP); Kentaro Ueda, Hyogo (JP)

Correspondence Address: LOWE HAUPTMAN GOPSTEIN, GILMAN AND BERNER LLP, SUITE 310, 1700 DIAGONAL ROAD, ALEXANDRIA, VA, 22314

(73) Assignee: NIPPON KANZAI CO., LTD.

(21) Appl. No.: 09/934,570

(22) Filed: Aug. 23, 2001

(30) Foreign Application Priority Data
Apr. 5, 2001 (JP) 2001-107738

(51) Int. Cl. G06F 17/60

(52) U.S. Cl. 705/40; 705/9

(57) ABSTRACT

The apparatus comprises the building diagnostic data input section that inputs building diagnostic data that quantitatively represents deterioration state of constituents of a building. The building repair plan summary sheet preparing section, electric equipment repair plan summary sheet preparing section, sanitary installation repair plan summary sheet preparing section, air conditioning equipment repair plan summary sheet preparing section, and the transportation equipment repair plan summary sheet preparing section calculate future repair period and cost for each constituent, based on the building diagnostic data. The output section outputs the calculation results at least in a tabular format.

### FIELD OF THE INVENTION

The present invention relates to a technology for building administration. The building administration is work such as making a plan of management jobs, building diagnosis, repair plan and repair cost, related to buildings, for example, a building which has a plurality of tenants.

### BACKGROUND OF THE INVENTION

Heretofore, general construction companies make repair plans and propose these to the building owners, as one of building maintenance services. These repair plans include repair periods and costs, respectively, with regard to architecture (external wall, metal fittings, etc.), electric equipments (receiving and transforming facilities, main power facilities, main wiring facilities, lighting facilities, etc.), mechanical and plumbing equipments (air conditioning and ventilation equipment, sanitary installation, plumbing equipment, etc.) and fire extinguishing equipment (fire equipment, indoor fire hydrant equipment, sprinkler equipment, etc.), for the purpose of maintaining and improving the building quality.

The concept of the building repair will now be described, with reference to FIG. 18. This figure represents the relation between number of years elapsed since new construction of the building (X-axis) and the capacity and function of the building (Y-axis). As is seen from this figure, if the capacity and function of the building at the time of new construction (number of years elapsed=0) is designated as 100%, the capacity and function of the building decrease with an increase of the number of years elapsed. The limit of comfortable capacity is said to be 70 to 80% of the capacity and function.

Accordingly, repair of a building is systematically performed in order to maintain the capacity and function of the building higher than 70 to 80%. When such an appropriate maintenance is performed, the durability can be extended. On the other hand, if maintenance is not performed, the capacity and function of the building becomes lower than 80%-70%, even if the number of years elapsed is small, thereby decreasing the durability.

Moreover, conventionally, building management companies issue bills for asking for the amount billed, consisting of variable expense and fixed expenses for each tenant of the building. The variable expenses include the Electricity charge, Water charge and the like. In this case, building management companies separately and manually sort out the meter-reading results of the watt-hour meter and water supply meter installed for each tenant.

In the above description, there has been described that the repair plans of the building proposed by general construction companies include repair periods and costs, respectively, with regard to the building, electric equipments, mechanical and plumbing equipments and fire extinguishing equipment. In these repair plans, the repair periods and costs are uniformly calculated, based on the durability of objects to be repaired generally.

The durability of objects to be repaired, however, is different among buildings due to peculiar circumstances of buildings (external environment, building area, status of use, etc.). Therefore, it is unreasonable to apply a repair plan consisting of a uniform repair period and cost, and it can be said that the reliability of the repair plan is low.

Heretofore, even if the building owner estimates future cost expenditure based on the repair plan, there is caused a difference between the estimated cost and the actual cost in many cases, thereby causing a problem in that there is a high possibility that the cost shared by the building owner increases. General building companies adopt a stance that the repair plan is only a reference, hence, when the actual cost exceeds the estimated cost, the cost increase is imposed on the building owner. There is a problem similar to the repair cost with regard to the management cost.

Moreover, when bills are issued to tenants, conventionally, the meter-reading results of the watt-hour meters and water supply meters must be sorted out by hand separately, which causes a problem in that lots of time is necessary for data processing, with an increase in the number of tenants.

### SUMMARY OF THE INVENTION

It is an object of the present invention to provide a method of and an apparatus for building management that can increase the reliability in the repair period, repair cost and future management cost related to the constituents of a building, and that can speed up data processing related to issuance of bills to tenants in the building. It is an another object of this invention to provide a computer program which can realize the method according to present invention on a computer.

According to one aspect of this invention, at least one deterioration state parameter that quantitatively represents a deterioration state of constituents of a building is input. Future repair period and future repair cost for each constituent is calculated based on the input deterioration state parameter. The calculation results are output at least in a tabular format.

According to another aspect of this invention, at least one deterioration state parameter that quantitatively represents a deterioration state of constituents of a building is input. Future management cost for each management job of the building is calculated based on the input deterioration state parameter. The calculation results are output at least in a tabular format.

According to still another aspect of this invention, at least light and fuel expenses data is collected for each tenant of a building in a predetermined cycle. Variable expenses for each tenant are calculated based on the light and fuel expenses data. A bill describing an amount billed including at least variable expenses for each tenant is issued.

According to still another aspect of this invention, at least one deterioration state parameter that quantitatively represents a deterioration state of constituents of a building is input. Future repair period and future repair cost for each constituent is calculated based on the deterioration state parameter and the calculation results are output at least in a tabular format. Future management cost for each management job of the building is calculated based on the deterioration state parameter and the calculation results are output at least in a tabular format.

According to still another aspect of this invention, at least one deterioration state parameter that quantitatively represents a deterioration state of constituents of a building is input. Future repair period and future repair cost for each constituent are calculated based on the deterioration state parameter and the calculation results are output at least in a tabular format. Future management cost for each management job of the building are calculated based on the deterioration state parameter and the calculation results are output at least in a tabular format. At least light and fuel expenses data for each tenant of a building is collected in a predetermined cycle. Variable expenses for each tenant are calculated based on the light and fuel expenses data and a bill describing an amount billed including at least the variable expenses for each tenant is issued.

Other objects and features of this invention will become apparent from the following description with reference to the accompanying drawings.

### BRIEF DESCRIPTION OF THE DRAWINGS

FIG. 1 is a block diagram showing the construction of a first embodiment according to the present invention;

FIG. 2 is a diagram showing one example of building diagnostic database 20 shown in FIG. 1;

FIG. 3 is a diagram showing one example of building diagnostic database 110 shown in FIG. 1;

FIG. 4 is a flowchart for explaining long-term repair plan processing in the first embodiment;

FIG. 5 is a diagram showing one example of a building repair plan summary sheet 200 in the first embodiment;

FIG. 6 is a diagram showing one example of an electric equipment repair plan summary sheet 210 in the first embodiment;

FIG. 7 is a diagram showing one example of a sanitary installation repair plan summary sheet 220 in the first embodiment;

FIG. 8 is a diagram showing one example of an air conditioning equipment repair plan summary sheet 230 in the first embodiment.;

FIG. 9 is a diagram showing one example of a transportation equipment repair plan summary sheet 240 in the first embodiment;

FIG. 10 is a diagram showing one example of a long-term repair plan integrated table 250 in the first embodiment;

FIG. 11 is a diagram showing one example of a long-term repair plan integrated graph 260 in the first embodiment;

FIG. 12 is a flowchart for explaining the building management cost calculation processing in the first embodiment;

FIG. 13 is a block diagram showing the construction of a second embodiment according to the present invention;

FIG. 14 is a diagram showing one example of the electricity and Water charge database 340 shown in FIG. 13;

FIG. 15 is a diagram showing one example of the format of a bill 400 issued by the bill issuing section 350 shown in FIG. 13;

FIG. 16 is a flowchart for explaining the operation in the second embodiment;

FIG. 17 is a block diagram showing the construction of a modified example of the first and second embodiments according to the present invention; and

FIG. 18 is a diagram for explaining the concept of building repair.

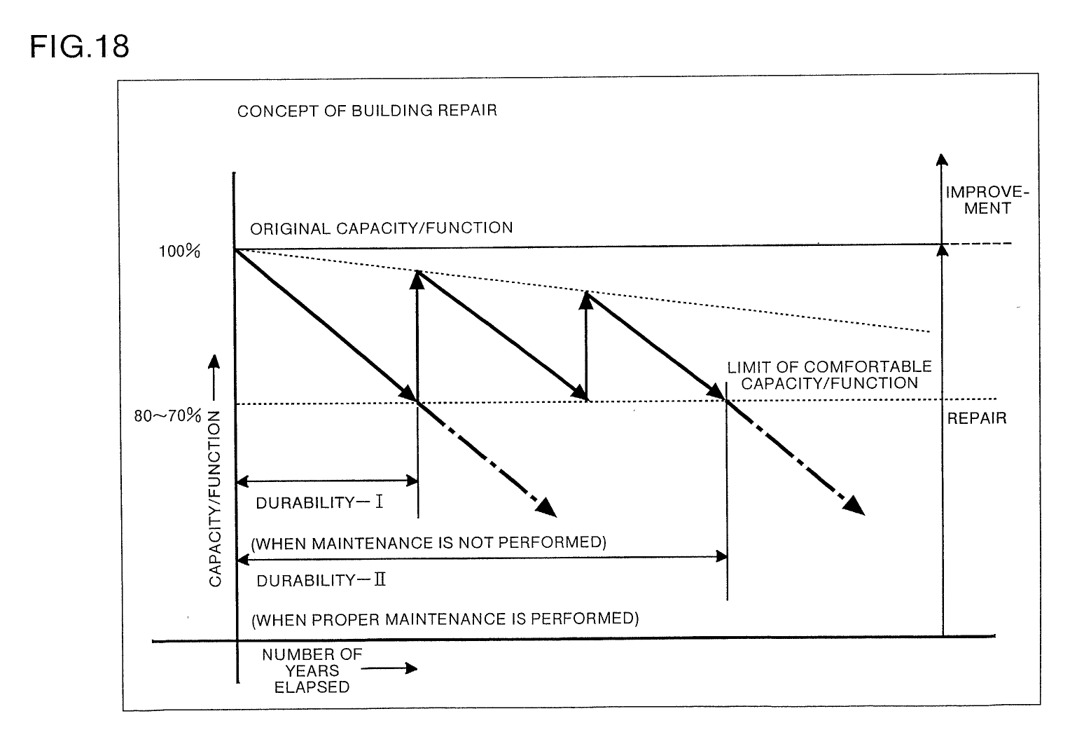

### DESCRIPTION OF THE PREFERRED EMBODIMENTS

Embodiments of the method of and apparatus for building management, and the computer program according to the present invention will now be described in detail, with reference to the accompanying drawings.

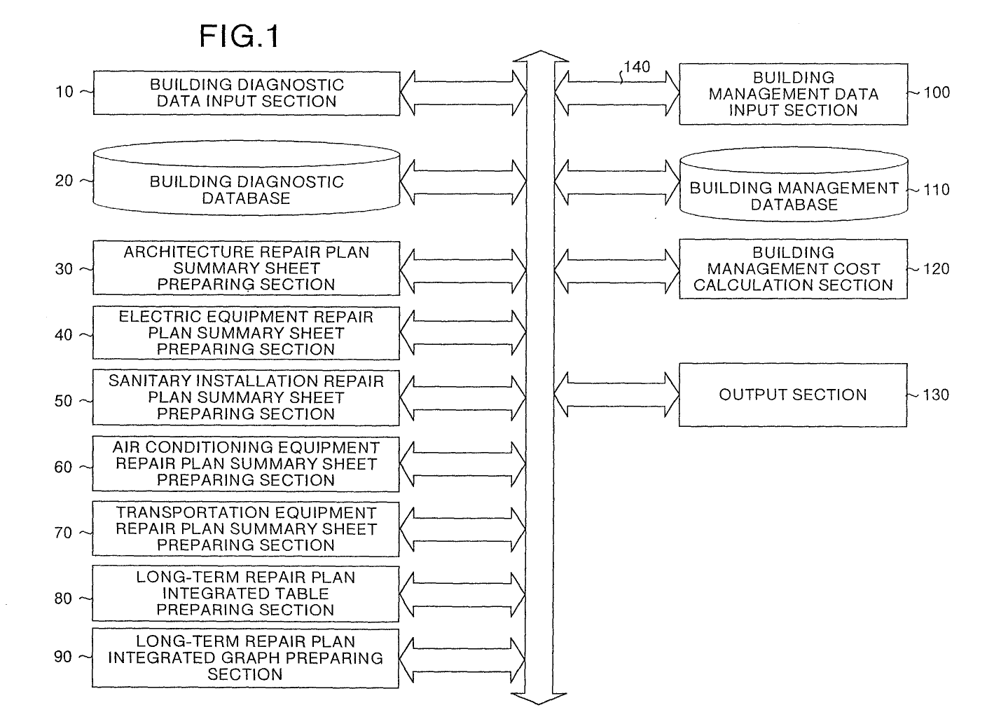

FIG. 1 is a block diagram showing the construction of a first embodiment according to the present invention. The building diagnostic data input section 10 is for inputting building diagnostic data obtained by diagnosing deterioration state of the building on the spot and historical information of the building repair described below, at the time of making a repair plan of the building. One example of an object to be diagnosed and the contents thereof in the building diagnosis will be explained below.

(I) Architecture

1) Water proof

(1) Rooftop and tower rooftop

(2) Balcony rooftop

2) External wall

(1) External wall painted wall

(2) Tower external wall and covering wall

(3) Sealing in each place

3) Metal fittings

(1) Front stainless steel sash and stainless steel ring shutter

(2) Elevator hall fire-protection wall in each floor

6) Refractory covering material of reinforcing bar

(1) Qualitative analysis test

(II) Electric Equipment

1) Receiving and transforming facilities

(1) Cubicle

2) Main line power equipment

(1) Power control board

(2) Wiring/piping

3) Lighting plug equipment

(1) Lighting distribution board

(2) Lighting fixture

7) Lightning rod installation

(III) Sanitary Installation

(IV) Air Conditioning Equipment

(V) Transportation Equipment

The above-described building diagnostic data will be explained in more detail shown below. This building diagnostic data comprises an object to be diagnosed, diagnosis result, evaluation, priority and photograph number. The object to be diagnosed is a part constituting the building described above, and an object of building diagnosis. The diagnosis result is a result of actually diagnosing the object to be diagnosed on the spot.

Evaluation quantitatively represents the deterioration degree of the object to be diagnosed, and is set in five stages of from 1 to 5 described below, depending on the diagnosis result. The priority quantitatively represents urgency of repair of the object to be diagnosed, and is set to seven stages of from A to G, depending on the diagnosis result. The photograph number is a number added to the photographic data of the object to be diagnosed.

Evaluation ranks:

5: There is only a slight problem in a normally aged deterioration state and the condition is good.

4: It is considered that future treatment will become necessary due to a problem caused by aged deterioration, but the current condition is good.

3: There is a problem and examination/treatment is urgent.

2: There is a problem to be solved urgently.

1: Cannot be used due to a failure.

Priority:

A: Requires urgent repair.

B: Requires repair within 1 to 5 years after construction.

C: Requires repair within 6 to 10 years after construction.

D: Requires repair within 11 to 15 years after construction.

E: Requires repair within 16 to 20 years after construction.

F: Requires repair within 21 to 25 years after construction.

G: Requires repair within 26 to 30 years after construction.

Object to be diagnosed, Diagnosis result, Evaluation ranks and Priority:

(I) Architecture

1) Water proof

(1) Rooftop and tower rooftop: Over 16 years have passed since completion, and the concrete surface of waterproof covering cinder has been greatly deteriorated or generation of moss is conspicuous. In order to protect the water resistant layer, it is necessary to waterproof by the urethane film.

Evaluation rank: 3

Priority: A

Photograph No.: 3, 5 to 11

(2) Balcony rooftop: The surface topcoat is deteriorated, and the roof drain is blocked (drainage of rain water is poor) due to generation of moss or the like. It results in leakage of rain, and hence it is necessary to repair the roof drain and to waterproof by the urethane film. Since deterioration can be also observed in the coping scrambling sealing, renovation is required.

Evaluation rank: 3

Priority: A

Photograph No.: 20 to 22

2) External wall

(1) External wall painted wall: Cracks have been generated on the front (east side) external wall due to extension and contraction of the external wall material, and blur and deterioration have advanced on the paintwork, due to air pollution. Cracks require adhesive reinforcement by means of injection of epoxy resin, and blur and deterioration on the paintwork require high-pressure cleaning and painting renovation.

Evaluation rank: 3

Priority: A p0 Photograph No.: 79 to 84

(2) Tower external wall and 1F approach covering wall Tower external wall: Painting is deteriorated, and since it results in future leakage, it is necessary to renovate painting on the south and east side where it is attacked by wind and rain without having an influence of the adjacent building. Also, the approach covering wall on the first floor (stone-pitching surface) is greatly deteriorated due to air pollution, and cleaning is necessary.

Evaluation rank: 3

Priority: A

Photograph No.: 4, 6

(3) Sealing in each place: Over 16 years has passed after completion, sealing in each place (coping scrambling and sash) is deteriorated and peeled off. Renovation is required.

Evaluation rank: 3

Priority: A

Photograph No.: 21

(II) Electric Equipment

(III) Sanitary Installation

(IV) Air Conditioning Equipment

(V) Transportation Equipment

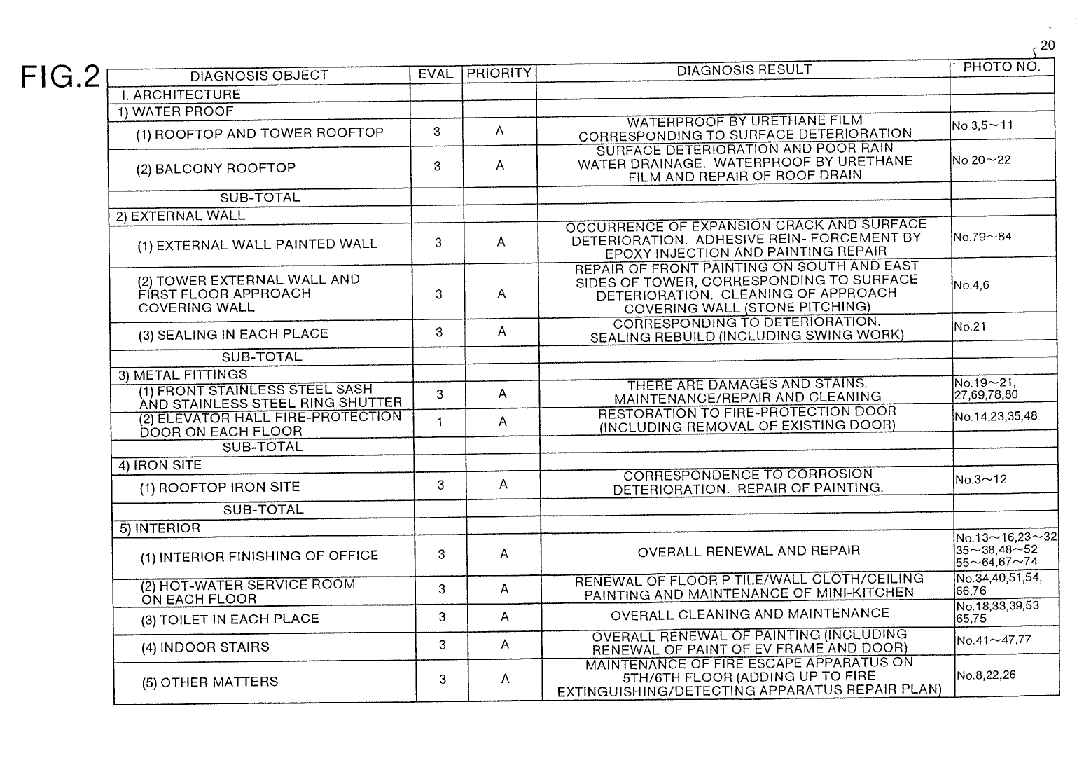

Returning to FIG. 1, a building diagnostic database 20 is database for storing building diagnostic data input by the building diagnostic data input section 10. This building diagnostic database 20 comprises, as shown in FIG. 2, fields of “Object to be diagnosed”, “evaluation”, “priority”, “diagnosis result”, and “photograph No.”.

Since these “object to be diagnosed” to “photograph No.” are the same as described above, the description thereof is omitted. In this figure, the building diagnostic data for “I. Architecture” is shown, but in the actual building diagnostic database 20, building diagnostic data for “II. Electric equipment”, “III. Sanitary installation”, “IV. Air conditioning equipment” and “V. Transportation equipment” is stored, respectively.

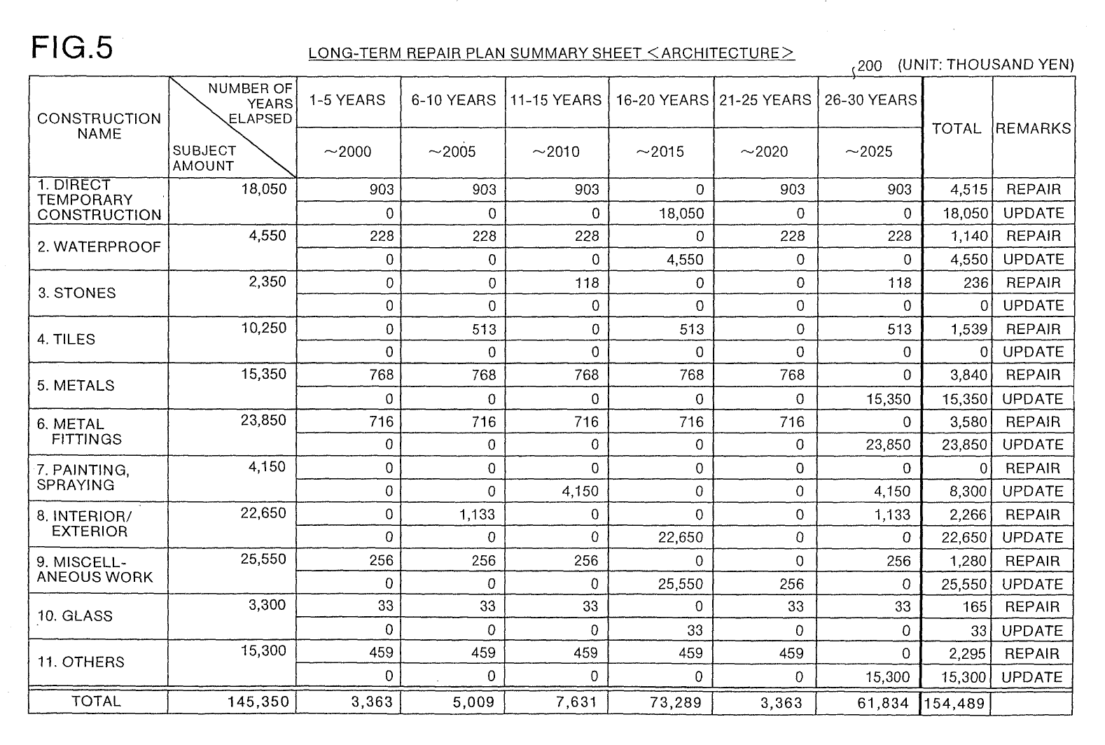

Returning to FIG. 1, a building repair plan summary sheet preparing section 30 prepares a building repair plan summary sheet 200 shown in FIG. 5, based on the building diagnostic data for “I. Architecture” stored in the building diagnostic database 20. This building repair plan summary sheet 200 is a table showing a long-term repair plan (1 to 30 years after construction) regarding architecture and comprises fields of “construction name”, “subject amount”, “number of years elapsed” in a unit of 5 years, “total” and “remarks”.

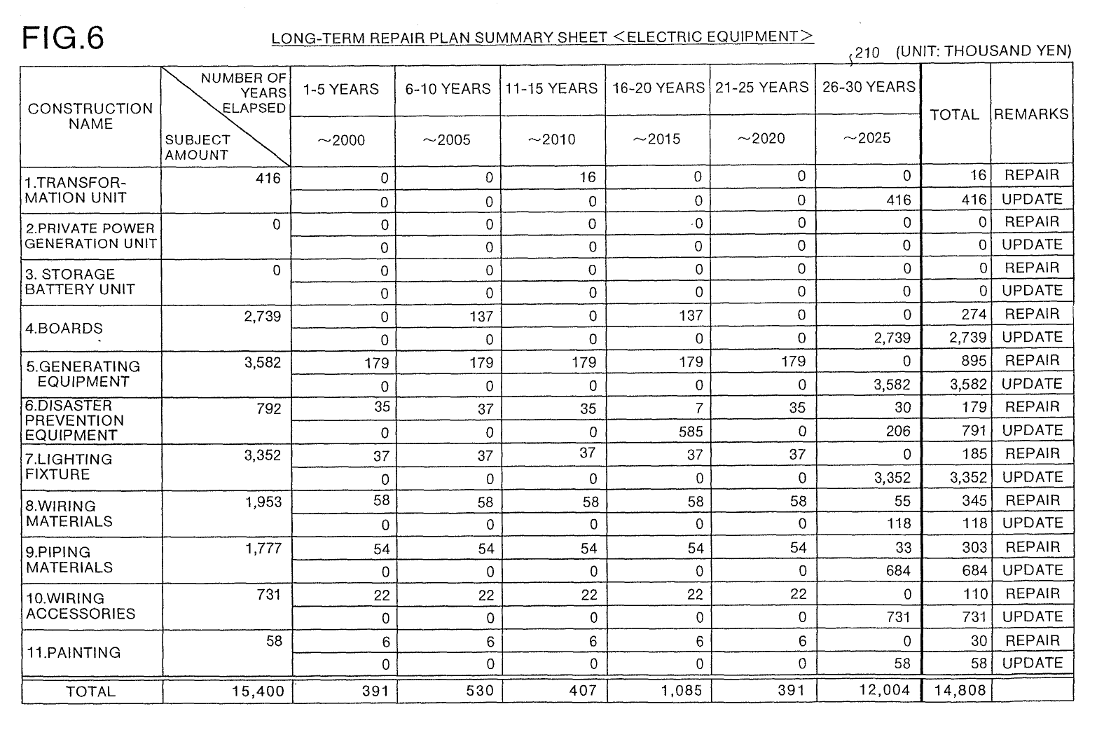

Returning to FIG. 1, an electric equipment repair plan summary sheet preparing section 40 prepares an electric equipment repair plan summary sheet 210 shown in FIG. 6, based on the building diagnostic data for “II. Electric equipment” stored in the building diagnostic database 20. This electric equipment repair plan summary sheet 210 is a table showing a long-term repair plan (1 to 30 years after construction) regarding electric equipment and comprises fields of “construction name”, “subject amount”, “number of years elapsed” in a unit of 5 years, “total” and “remarks”.

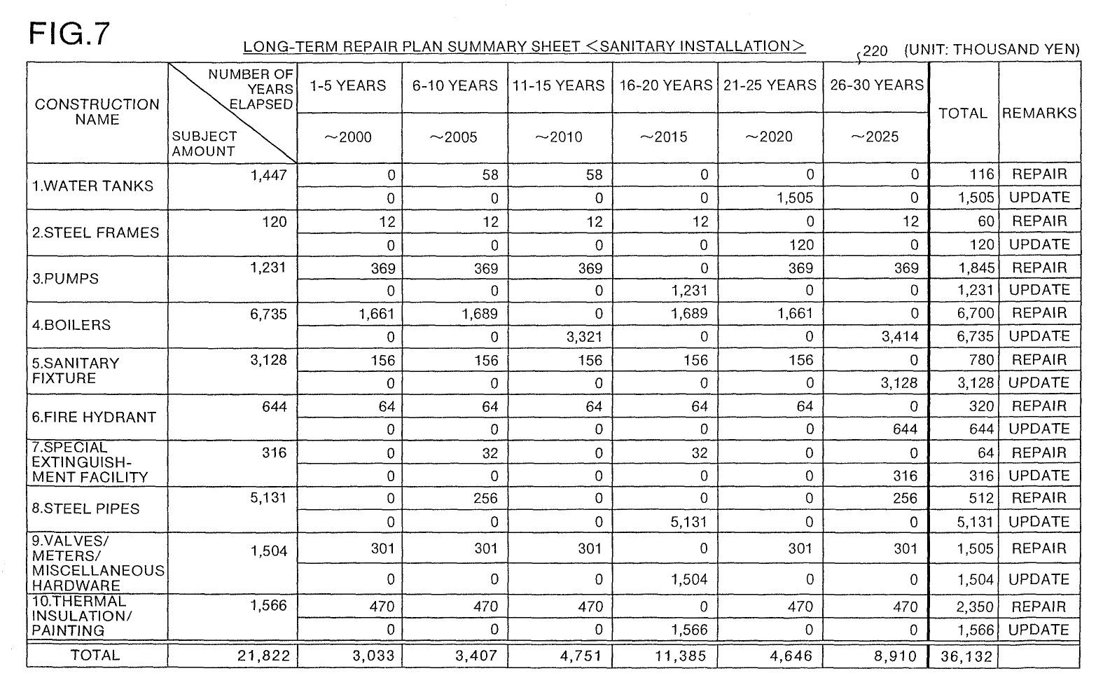

Returning to FIG. 1, a sanitary installation repair plan summary sheet preparing section 50 prepares a sanitary installation repair plan summary sheet 220 shown in FIG. 7, based on the building diagnostic data for “III. Sanitary installation” stored in the building diagnostic database 20. This sanitary installation repair plan summary sheet 220 is a table showing a long-term repair plan (1 to 30 years after construction) regarding sanitary installation and comprises fields of “construction name”, “subject amount”, “number of years elapsed” in a unit of 5 years, “total” and “remarks”.

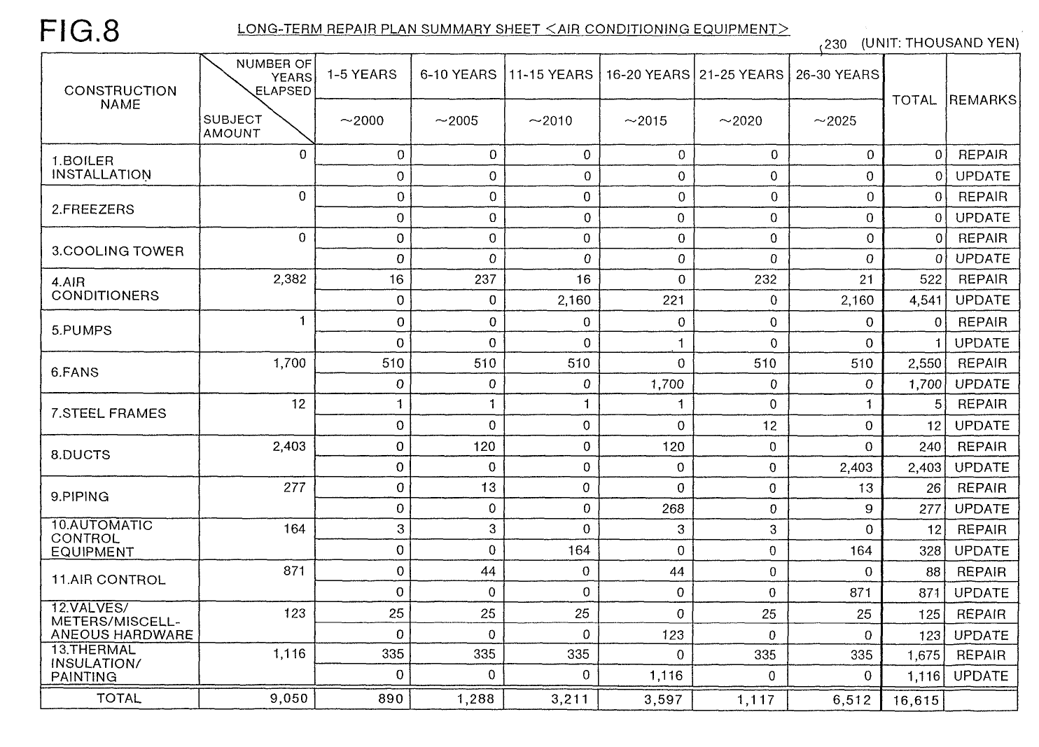

Returning to FIG. 1, an air conditioning equipment repair plan summary sheet preparing section 60 prepares an air conditioning equipment repair plan summary sheet 230 shown in FIG. 8, based on the building diagnostic data for “IV. Air conditioning equipment” stored in the building diagnostic database 20. This air conditioning equipment repair plan summary sheet 230 is a table showing a long-term repair plan (1 to 30 years after construction) regarding air conditioning equipment and comprises fields of “construction name”, “subject amount”, “number of years elapsed” in a unit of 5 years, “total” and “remarks”.

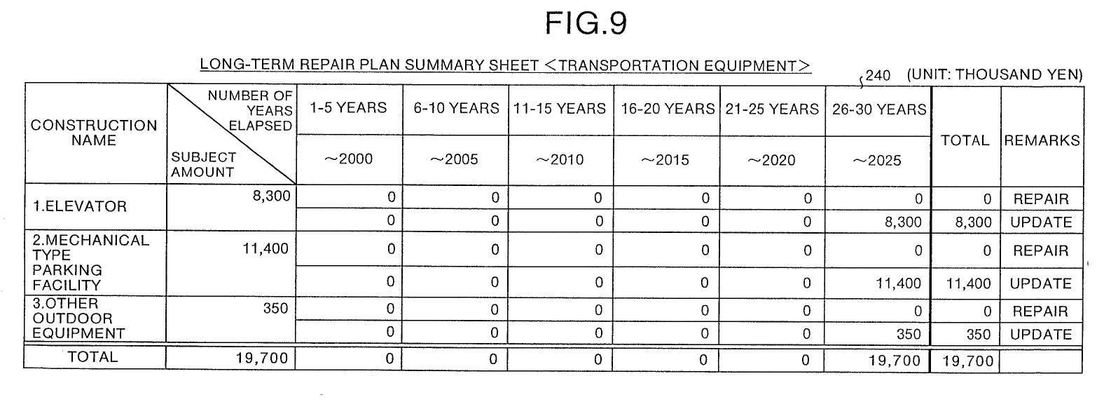

Returning to FIG. 1, a transportation equipment repair plan summary sheet preparing section 70 prepares a transportation equipment repair plan summary sheet 240 shown in FIG. 9, based on the building diagnostic data for “V. Transportation equipment” stored in the building diagnostic database 20. This transportation equipment repair plan summary sheet 240 is a table showing a long-term repair plan (1 to 30 years after construction) regarding transportation equipment and comprises fields of “construction name”, “subject amount”, “number of years elapsed” in a unit of 5 years, “total” and “remarks”.

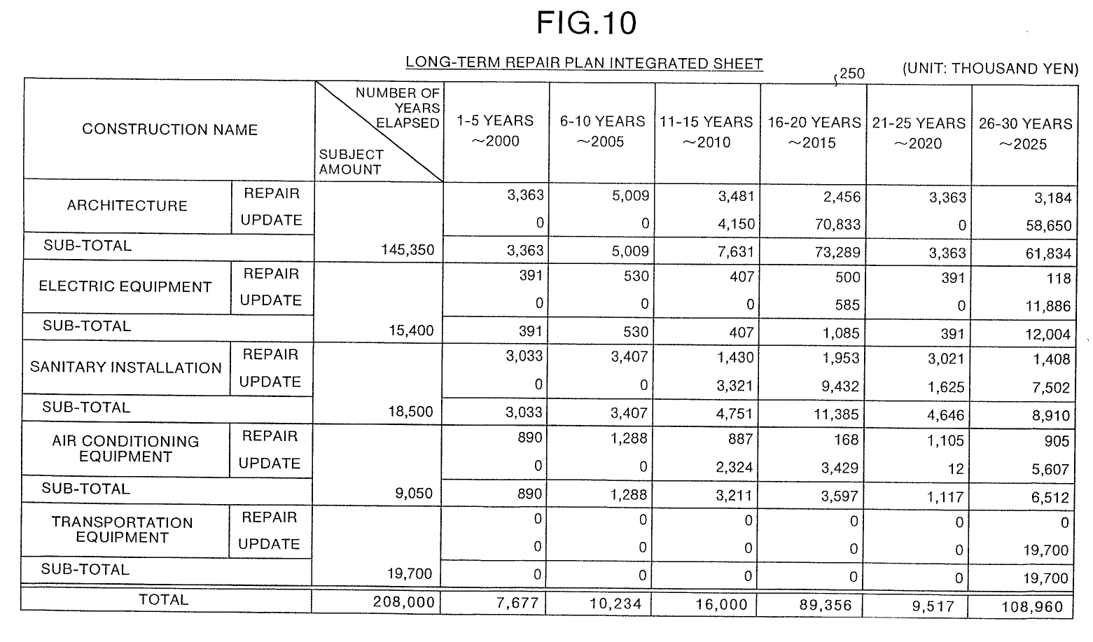

Returning to FIG. 1, a long-term repair plan integrated table preparing section 80 prepares a long-term repair plan integrated table 250 shown in FIG. 10, based on the above-described building repair plan summary sheet 200 (see FIG. 5), electric equipment repair plan summary sheet 210 (see FIG. 6), sanitary installation repair plan summary sheet 220 (see FIG. 7), air conditioning equipment repair plan summary sheet 230 (see FIG. 8), and transportation equipment repair plan summary sheet 240 (see FIG. 9). This long-term repair plan integrated table 250 is a table showing a long-term repair plan (1 to 30 years after construction) regarding “I. Architecture”, “II. Electric equipment”, “III. Sanitary installation”, “IV. Air conditioning equipment” and “V. Transportation equipment”, respectively, in a list.

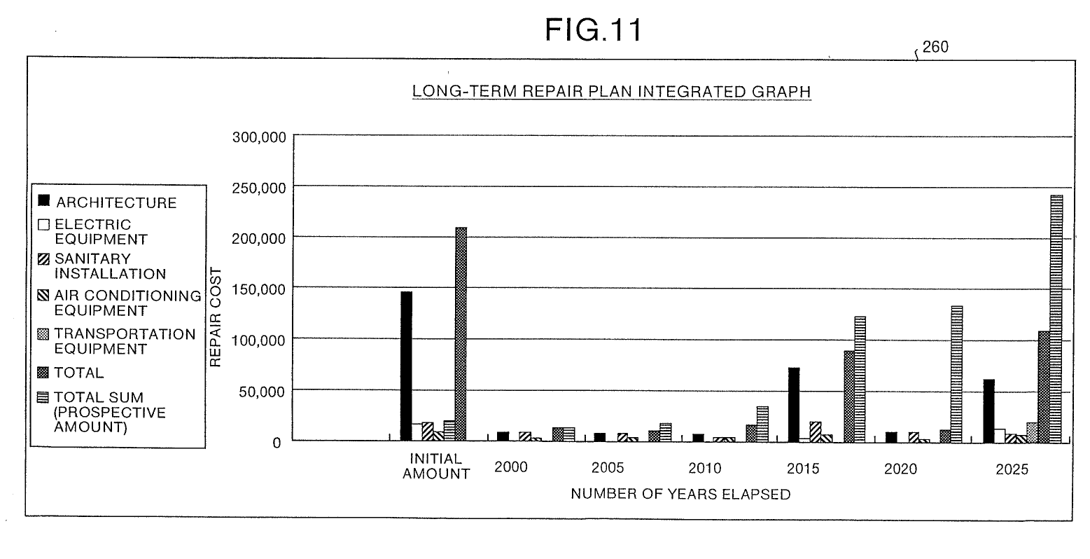

Returning to FIG. 1, a long-term repair plan integrated graph preparing section 90 prepares a long-term repair plan integrated graph 260 shown in FIG. 11, based on the above-described long-term repair plan integrated table 250 (see FIG. 10). This long-term repair plan integrated graph 260 is a table in which the relation between number of years elapsed and repair costs with regard to “I. Architecture”, “II. Electric equipment”, “III. Sanitary installation”, “IV. Air conditioning equipment” and “V. Transportation equipment”, respectively, in a visual form.

Returning to FIG. 1, a building management data input section 100 is for inputting the building management data. The building management data is data in which labor for each job regarding the building management described below is converted into a numerical value, and it is set by a person in charge, based on the diagnostic data of the building described above.

(1) integrated management job

(2) building administration job

(3) cleaning job

(4) equipment management job

(5) environmental sanitation job

(6) guard job

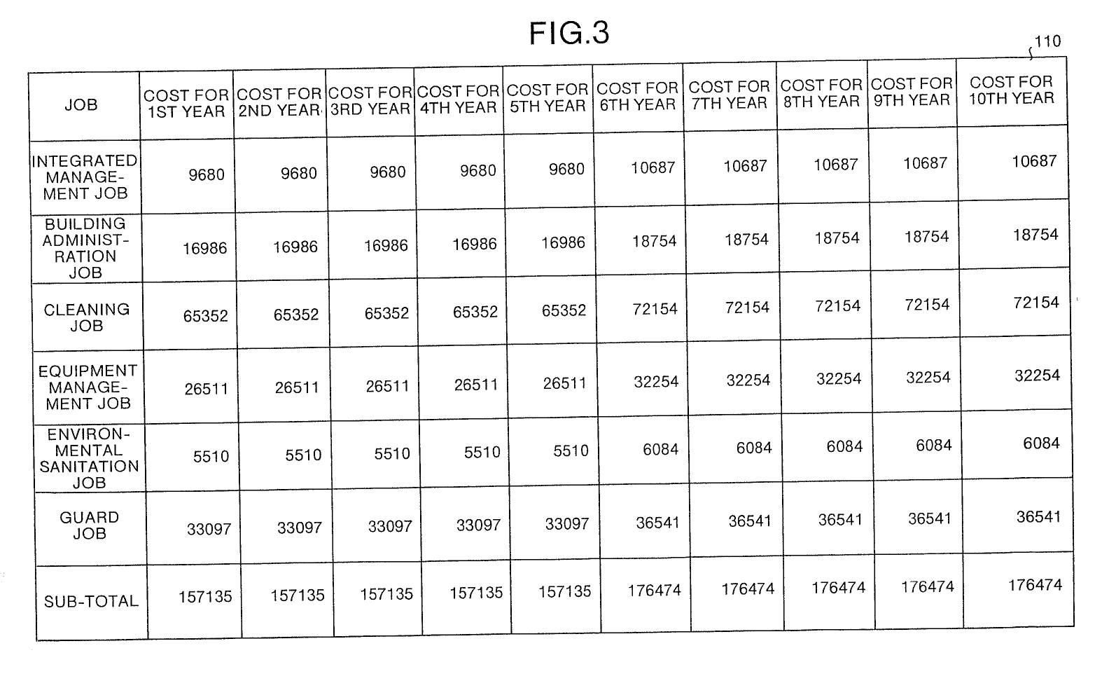

Building management database 110 is, as shown in FIG. 3, database in which costs incurred for each job regarding the building management is stored in a unit of one year for the first to the tenth year. A building management cost calculation section 120 calculates the cost for each job in a unit of one year, based on the building management data input from the building management data input section 100. An output section 130 is a display, a printer or the like, and outputs data of the building repair plan and the building management cost. A bus 140 connects each section. Long-term repair plan processing:

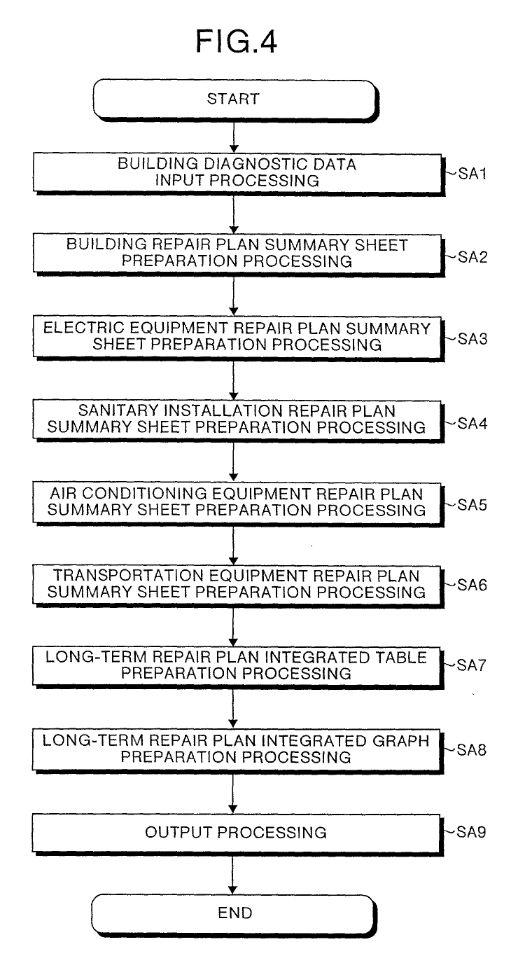

The long-term repair plan processing in the first embodiment will now be described in detail, with reference to the flowchart shown in FIG. 4. In the case of performing building diagnosis, a person in charge who has the expertise regarding the building maintenance confirms the completion information such as the party to make a deal/contract with, client and building name, according to the completion document of the building. Here, one example of the completion information described in the completion document is listed below:

1. Party to make a deal/contract with: AAA Co., Ltd.

2. Client: BBB Co., Ltd.

3. Building name: CCC Office Building

4. Building location: 1-2-3 XX, XX-ku, Tokyo

5. Scale: 20 stories above ground and 3 below, and tower on the 20th floor

6. Use: Office

7. Number of houses: 1

8. Structure: SRC built

9. Plottage: 1000 m²

10. Building area: 500 m²

11. Architectural area: 5000 m²

12. Exclusive area: 3000 m²

13. Completion date: April 1995

14. Equipment list: Air conditioning equipment, receiving and transforming facilities

15. Designer: DDD Architectural Design Institution

16. Constructor: EEE Construction Company Ltd.

17. Construction costs: Eight hundred million yen.

Then, the person in charge confirms the repair history regarding the equipment by means of the repair history book or the like. The information regarding the repair history is used for modifying the repair cycle of the equipment. The information of the repair history includes the following:

1. building repair history;

2. electric equipment repair history;

3. sanitary installation repair history;

4. air conditioning equipment repair history;

5. transportation equipment repair history.

When the above-described confirmation of the completion information and the repair history information has been completed, the person in charge goes to the site of the building to be diagnosed, to perform careful diagnosis with regard to the above-described diagnosis object, and to evaluate and determine the priority. At this time, the person in charge takes photographs of the diagnosis object with a digital camera or the like.

Then, when the building diagnosis has been completed, the person in charge sequentially inputs the building diagnostic data (diagnosis object, evaluation, priority and photographic data), using the building diagnostic data input section 10 (see FIG. 1), in step SA1 shown in FIG. 4. Subsequently, the person in charge inputs the above-described information regarding the repair history, using the building diagnostic data input section 10. As a result, the building diagnostic data is sequentially stored in the building diagnostic database 20 (see FIG. 2).

In step SA2, the building repair plan summary sheet preparing section 30 calculates the repair cost for every number of years elapsed from a building repair cost table (not shown), using, as a key, the evaluation and priority of the building diagnostic data of “I. Architecture” stored in the building diagnostic database 20 (see FIG. 2). This building repair cost table is a table representing the correspondence between the evaluation and priority, and the repair cost, respectively, with regard to the respective construction name shown in FIG. 5. If the equipment has been repaired, the starting point of the repair cycle and the number of years elapsed is updated, based on the repair history information.

Then, the building repair plan summary sheet preparing section 30 refers to the update period and cost from a building update cost table (not shown) representing the correspondence between the durability, the update period and the cost for each constituent of the building. If the equipment has been repaired, the update period is updated, based on the repair history information. Then, the building repair plan summary sheet preparing section 30 prepares the building repair plan summary sheet 200 shown in FIG. 5.

In step SA3, the electric equipment repair plan summary sheet preparing section 40 calculates the repair cost for every number of years elapsed from an electric equipment repair cost table (not shown), using, as a key, the evaluation and priority of the building diagnostic data of “II. Electric equipment” stored in the building diagnostic database 20 (see FIG. 2). This electric equipment repair cost table is a table representing the correspondence between the evaluation and priority, and the repair cost, respectively, with regard to the respective construction name shown in FIG. 6. If the electric equipment has been repaired, the starting point of the repair cycle and the number of years elapsed is updated, based on the repair history information.

Then, the electric equipment repair plan summary sheet preparing section 40 refers to the update period and cost from an electric equipment update cost table (not shown) representing the correspondence between the durability, the update period and the cost for each constituent of the electric equipment. If the equipment has been repaired, the update period is updated, based on the repair history information. Then, the electric equipment repair plan summary sheet preparing section 40 prepares the electric equipment repair plan summary sheet 210 shown in FIG. 6.

In step SA4, the sanitary installation repair plan summary sheet preparing section 50 calculates the repair cost for every number of years elapsed from a sanitary installation repair cost table (not shown), using, as a key, the evaluation and priority of the building diagnostic data of “III. Sanitary installation” stored in the building diagnostic database 20 (see FIG. 2). This sanitary installation repair cost table is a table representing the correspondence between the evaluation and priority, and the repair cost, respectively, with regard to the respective construction name shown in FIG. 7. If the sanitary installation equipment has been repaired, the starting point of the repair cycle and the number of years elapsed is updated, based on the repair history information.

Then, the sanitary installation repair plan summary sheet preparing section 50 refers to the update period and cost from a sanitary installation update cost table (not shown) representing the correspondence between the durability, the update period and the cost for each constituent of the sanitary installation. If the sanitary installation equipment has been repaired, the update period is updated, based on the repair history information. Then, the sanitary installation repair plan summary sheet preparing section 50 prepares the sanitary installation repair plan summary sheet 220 shown in FIG. 7.

In step SA5, the air conditioning equipment repair plan summary sheet preparing section 60 calculates the repair cost for every number of years elapsed from an air conditioning equipment repair cost table (not shown) , using, as a key, the evaluation and priority of the building diagnostic data of “IV. Air conditioning equipment” stored in the building diagnostic database 20 (see FIG. 2). This air conditioning equipment repair cost table is a table representing the correspondence between the evaluation and priority, and the repair cost, respectively, with regard to the respective construction name shown in FIG. 8. If the air conditioning equipment has been repaired, the starting point of the repair cycle and the number of years elapsed is updated, based on the repair history information.

Then, the air conditioning equipment repair plan summary sheet preparing section 60 refers to the update period and cost from an air conditioning equipment update cost table (not shown) representing the correspondence between the durability, the update period and the cost for each constituent of the air conditioning equipment. If the air conditioning equipment has been repaired, the update period is updated. Then, the air conditioning equipment repair plan summary sheet preparing section 60 prepares the air conditioning equipment repair plan summary sheet 230 shown in FIG. 8.

In step SA6, the transportation equipment repair plan summary sheet preparing section 70 calculates the repair cost for every number of years elapsed from a transportation equipment repair cost table (not shown), using, as a key, the evaluation and priority of the building diagnostic data of “V. Transportation equipment” stored in the building diagnostic database 20 (see FIG. 2). This transportation equipment repair cost table is a table representing the correspondence between the evaluation and priority, and the repair cost, respectively, with regard to the respective construction name shown in FIG. 9. If the transportation equipment has been repaired, the starting point of the repair cycle and the number of years elapsed is updated, based on the repair history information.

Then, the transportation equipment repair plan summary sheet preparing section 70 refers to the update period and cost from a transportation equipment update cost table (not shown) representing the correspondence between the durability, the update period and the cost for each constituent of the transportation equipment. If the transportation equipment has been repaired, the update period is updated. Then, the transportation equipment repair plan summary sheet preparing section 70 prepares the transportation equipment repair plan summary sheet 240 shown in FIG. 9.

In step SA7, the long-term repair plan integrated table preparing section 80 prepares a long-term repair plan integrated table 250 shown in FIG. 10, based on the total costs for each number of years elapsed (repair, update) of the building repair plan summary sheet 200 (see FIG. 5), the electric equipment repair plan summary sheet 210 (see FIG. 6), the sanitary installation repair plan summary sheet 220 (see FIG. 7), the air conditioning equipment repair plan summary sheet 230 (see FIG. 8), and the transportation equipment repair plan summary sheet 240 (see FIG. 9), prepared in step SA2 to step SA6, respectively. This long-term repair plan integrated table 250 clearly shows the cost in a unit five years, from 1 to 30 years after construction, regarding the architecture to the transportation equipment, respectively.

In step SA8, the long-term repair plan integrated graph preparing section 90 prepares a long-term repair plan integrated graph 260 shown in FIG. 11, based on the long-term repair plan integrated table 250 (see FIG. 10). In this long-term repair plan integrated graph 260, there are shown the number of years elapsed On the X-axis, and respective repair costs of from the architecture to the transportation equipment, the total cost and the sum On the Y-axis, to thereby show the cost visually.

In step SA9, the output section 130 respectively outputs the building repair plan summary sheet 200 (see FIG. 5), the electric equipment repair plan summary sheet 210 (see FIG. 6), the sanitary installation repair plan summary sheet 220 (see FIG. 7), the air conditioning equipment repair plan summary sheet 230 (see FIG. 8), the transportation equipment repair plan summary sheet 240 (see FIG. 9), the long-term repair plan integrated table 250 (see FIG. 10) and the long-term repair plan integrated graph 260 (see FIG. 11) prepared in step SA2 to step SA8, respectively. Building management cost calculation processing:

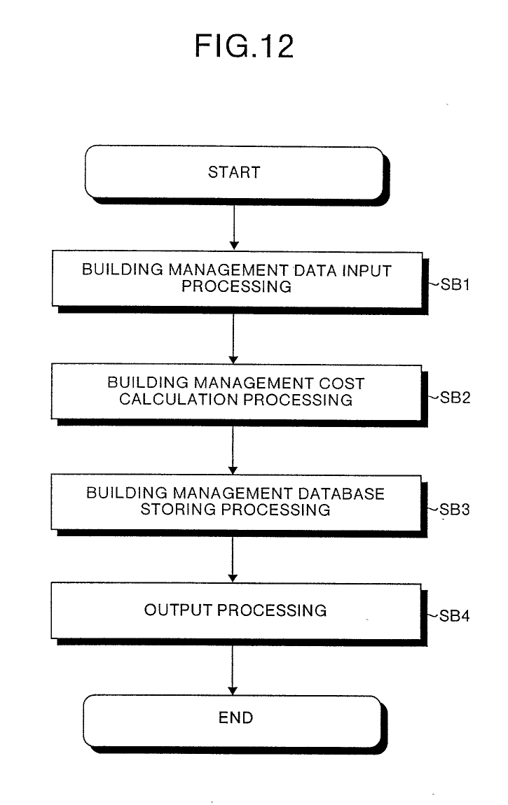

The building management cost calculation processing in the first embodiment will now be described in detail, with reference to the flowchart shown in FIG. 12. The above-described person in charge goes to the site of the building to be diagnosed, to perform careful diagnosis with regard to the above-described diagnosis object, and then sets the building management data (data obtained by converting the labor in each job into a numerical value), for each job (integrated management job, building administration job, cleaning job, equipment management job, environmental sanitation job, guard job) regarding the building management shown in FIG. 3, based on this diagnosis result.

Then, in step SB1 shown in FIG. 12, the person in charge inputs the above building management data, respectively, for each job, by the building management data input section 100 (see FIG. 1). As a result, in step SB2, the building management cost calculation section 120 multiplies the building diagnostic data for each job by a preset unit cost, as shown in FIG. 3. Here, the unit cost is a certain amount for the first to the fifth years, and is the amount obtained by multiplying the certain amount by a rate of price increase for the sixth to the tenth years. Moreover, the building management cost calculation section 120 calculates the sub-total of the cost for each job, respectively, for the first to the tenth years.

In step SB3, the building management cost calculation section 120 stores the cost calculated in step SB2 in the building management database 110 shown in FIG. 3. In step SB4, the output section 130 outputs the data of the building management cost stored in the building management database 110. Here, the cost required for the above-described repair and the cost required for the management are guaranteed by the building management company as the upper limit of the actual cost to be paid by the building owner.

As described above, according to the first embodiment, the future repair period and repair cost are calculated for each constituent, based on the evaluation and priority (deterioration state parameter) of the constituents of the building, and the calculation results are output at least in a tabular format (see FIG. 5 to FIG. 10), the repair period and the repair cost can be calculated in accordance with the actual state of deterioration of the building. As a result, the reliability in the repair period and the repair cost can be increased, and an increase in the cost shared by the building owner can be reduced.

Furthermore, since the repair period and repair cost are output in a graphic format (see FIG. 11) for each constituent of the building, the repair period and repair cost can be expressed visually, and as a result, more easily understandable data can be provided.

Furthermore, since the repair cost is guaranteed by the building management company as the upper limit of the actual repair cost to be paid by the building owner, an increase in the cost shared by the building owner can be made zero, thereby quite high service can be provided to the building owner.

Furthermore, since the future management cost is calculated for each management job of the building, based on the evaluation and priority (deterioration state parameter) quantitatively representing the deterioration state of constituents of the building, and the calculation results are output at least in a tabular format (see FIG. 3), the management cost can be calculated in accordance with the actual state of deterioration of the building. As a result, the reliability in the management cost can be increased, and an increase in the cost shared by the building owner can be reduced.

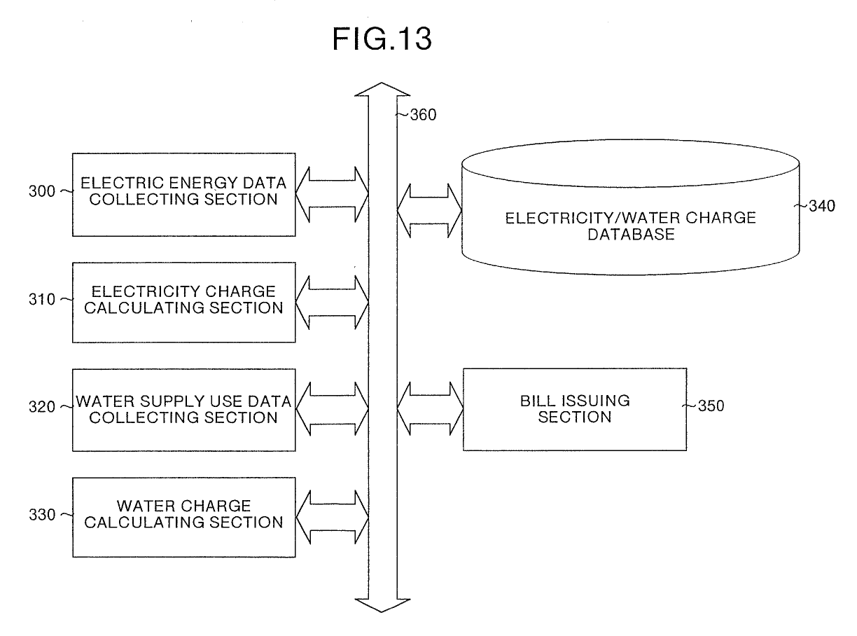

FIG. 13 is a block diagram showing the construction of a second embodiment according to the present invention. In this figure, an electric energy data collecting section 300 collects the electric energy data for each tenant of the building, respectively. An electricity charge calculating section 310 calculates the electricity charge for each tenant, based on the electric energy data respectively collected by the electric energy data collecting section 300.

A water supply use data collecting section 320 collects the water supply use data for each tenant of the building, respectively. A water charge calculating section 330 calculates the water charge for each tenant, based on the water supply use data respectively collected by the water supply use data collecting section 320.

The electricity and water charge database 340 is database for storing data regarding the electricity charge and water charge for each tenant calculated by the electricity charge calculating section 310 and the water charge calculating section 330, respectively.

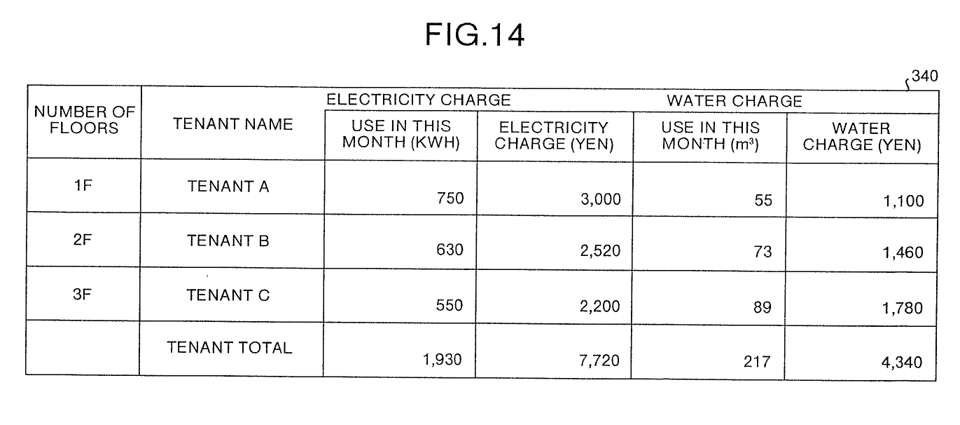

FIG. 14 is a diagram showing one example of the electricity and water charge database 340 shown in FIG. 13. The electricity and water charge database 340 shown in this figure comprises fields of “number of floors”, “tenant name”, “electricity charge” and “water charge”.

“Number of floors” represents the number of floors of the building. “Tenant name” represents the names of tenants in each floor. “Electricity charge” comprises fields of “Use in this month” and “Electricity charge”. “Water charge” comprises fields of “Use in this month” and “Water charge”.

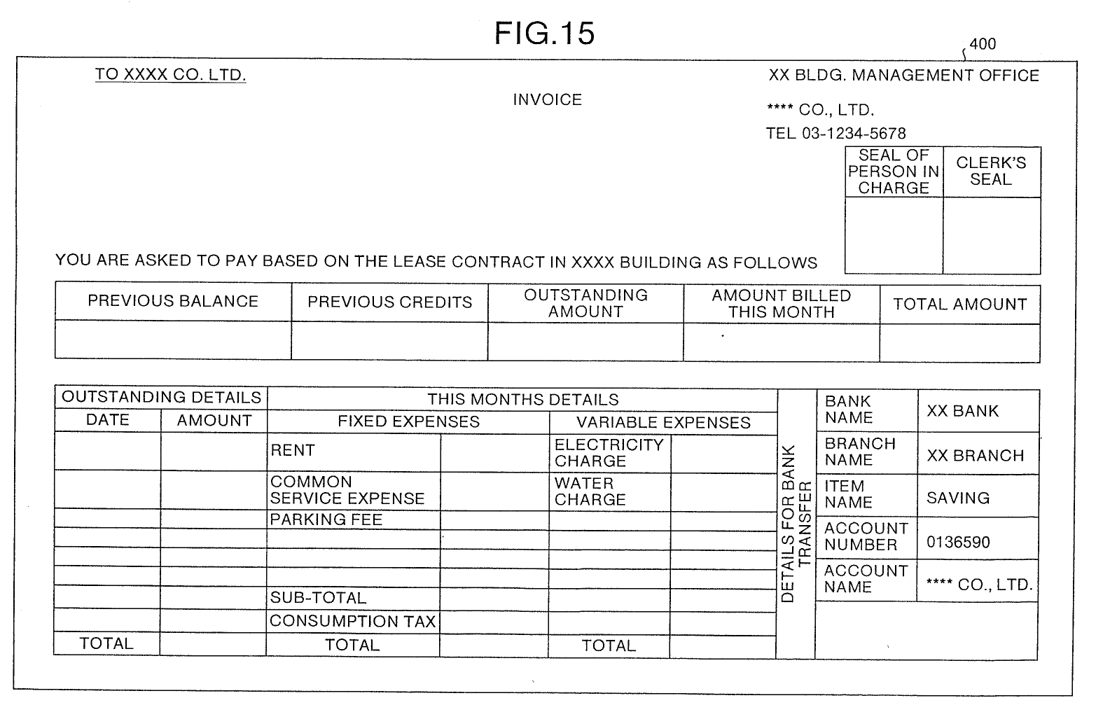

Returning to FIG. 13, the bill issuing section 350 issues a bill regarding the variable expenses obtained from the electricity and water charge database 340 (electricity charge and water charge) and a preset fixed expenses (rent, common service expense and parking fee) for each tenant, respectively. This bill issuing section 350 uses a format of a bill 400 shown in FIG. 15 to issue a bill to each tenant. The construction of the above-described second embodiment may be combined with the construction of the above-described first embodiment.

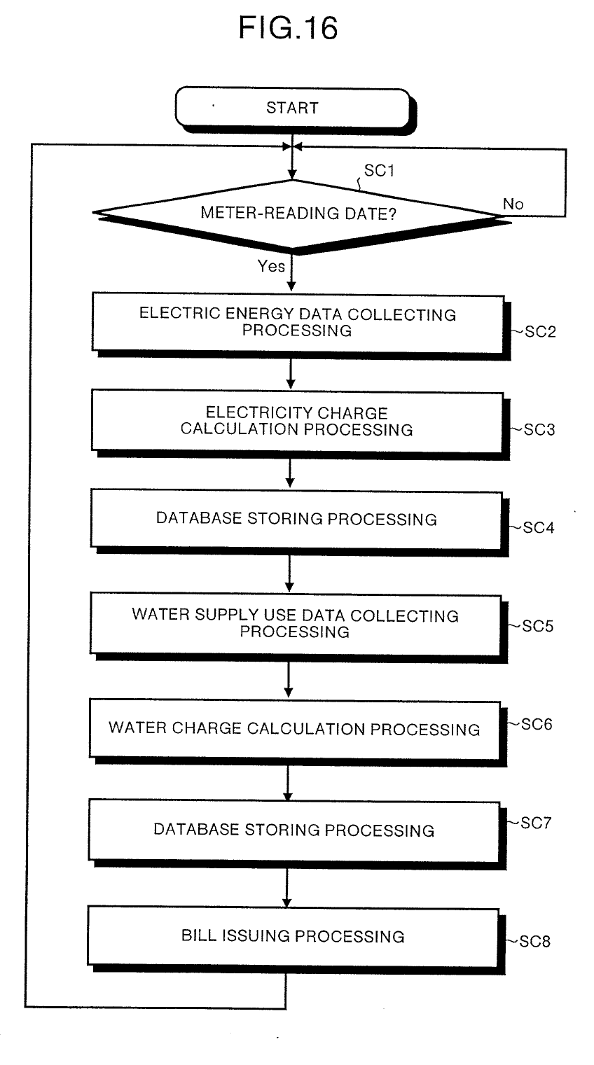

Next, the operation in the above-described second embodiment will be described with reference to the flowchart shown in FIG. 16. In step SC1 shown in this figure, it is judged whether or not it is the meter-reading date of the watt-hour meter and the water supply meter (for example, end of the month). When this judgment result is “No”, this judgment is repeated.

When the judgment result in step SC1 becomes “Yes”, then in step SC2, the electric energy data collecting section 300 collects the electric energy data from the watt-hour meter corresponding to each tenant, respectively. In step SC3, the electricity charge calculating section 310 calculates the electricity charge for each tenant, by multiplying the preset unit price of energy by the electric energy data collected in step SC2.

In step SC4, the electric energy data collecting section 300 stores the electric energy data and the total, respectively, in each record of the “use in this month” (electricity charge) of the electricity and water charge database 340 shown in FIG. 14. Also, the electricity charge calculating section 310 stores the electricity charge and the total, respectively, in each record of the “Electricity charge” of the electricity and water charge database 340.

In step SC5, the water supply use data collecting section 320 collects the water supply use data from the water supply meter corresponding to each tenant, respectively. In step SC6, the water charge calculating section 330 calculates the water charge for each tenant, by multiplying the predetermined unit price of water use by the water supply use data collected in step SC4, respectively.

In step SC7, the water supply use data collecting section 320 stores the water supply use data and the total in each record of the “use in this month” (Water charge) of the electricity and water charge database 340. Also, the water charge calculating section 330 stores the water charge and the total in each record of the “water charge” in the electricity and water charge database 340.

In step SC8, the bill issuing section 350 adds the electricity charge and the water charge obtained from the electricity and water charge database 340 (see FIG. 14) in the format of the bill 400 shown in FIG. 15, and applies a preset fixed expense thereto, to thereby issue a bill for each tenant.

As described above, according to the second embodiment, the electricity charge and the water charge (variable expenses) for each tenant are calculated based on the electric energy data and the water supply use data (light and fuel expenses) for each tenant of the building collected on the meter-reading date (predetermined period), and a bill describing an amount billed including at least variable expenses (see FIG. 15) is issued for each tenant. As a result, speed-up in the data processing in the management company can be achieved.

As described above, the first embodiment and the second embodiment according to the present invention have been described in detail with reference to drawings. The specific configuration example, however, is not limited to these first and second embodiments, and modifications in design are included in the present invention without departing from the scope of the present invention.

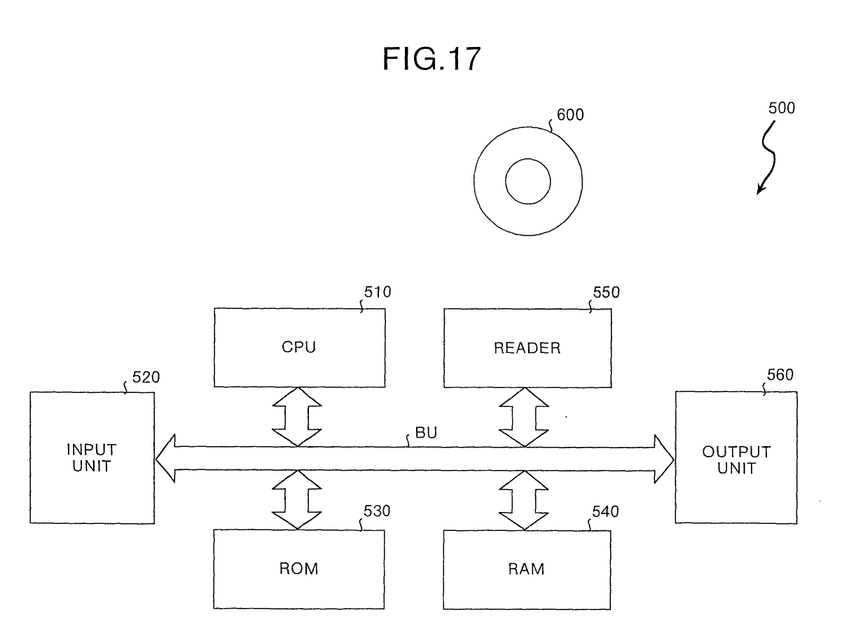

For example, in the above-described first and second embodiments, a series of processing regarding the building management may be executed by recording the building management program for realizing the afore-mentioned functions on a computer readable recording medium 600 shown in FIG. 17, and reading and executing the building management program recorded on this recording medium 600 by a computer 500 shown in the figure.

The computer 500 shown in FIG. 17 comprises a CPU 510 for executing the building management program, an input unit 520 such as a keyboard, a mouse and the like, a ROM (Read Only Memory) 530 for storing various data, a RAM (Random Access Memory) 540 for storing operation parameter or the like, a reader 550 for reading the building management program from the recording medium 600, an output unit 560 such as a display, a printer and the like, and a bus BU for connecting each section.

The CPU 510 reads the building management program stored in the recording medium 600 via the reader 550, and executes the building management program to thereby execute a series of processing regarding the above-described building management. The recording medium 600 includes not only portable recording media such as optical disks, floppy disks or hard disks, but also transmission media that record and keep the data temporarily like a network.

As described above, according to one aspect of this invention, future repair period and repair cost are calculated for each constituent of the building, based on the deterioration state parameter quantitatively representing the deterioration state of constituents of the building, and this calculation results are output at least in a tabular format. Hence, the repair period and the repair cost can be calculated in accordance with the actual state of deterioration of the building. As a result, there are such effects that the reliability in the repair period and the repair cost can be increased, and an increase in the cost shared by the building owner can be reduced.

Furthermore, since the repair period and the repair cost are output in a graphic format for each constituent of the building, the repair period and repair cost can be expressed visually, and there is such an effect that easily understandable data can be provided.

Furthermore, since the repair cost is guaranteed by the building management company as the upper limit of the actual repair cost to be paid by the building owner, an increase in the cost shared by the building owner can be made zero, and there is such an effect that quite high service can be provided to the building owner.

According to another aspect of this invention, since the future management cost is calculated for each management job of the building, based on the deterioration state parameter quantitatively representing the deterioration state of constituents of the building, and the calculation results are output at least in a tabular format, the management cost can be calculated in accordance with the actual state of deterioration of the building. As a result, there are such effects that the reliability in the management cost can be increased, and an increase in the cost shared by the building owner can be reduced.

According to still another aspect of this invention, variable expenses for each tenant are calculated based on the light and fuel expenses for each tenant of the building collected in a predetermined cycle, and a bill describing the amount billed including at least the variable expenses is issued for each tenant. As a result, there is such an effect that speed-up in the data processing in the management company can be attained.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer program for making a computer realize the functions of:
an input unit which inputs at least one deterioration state parameter that quantitatively represents a deterioration state of constituents of a building;
a calculation unit which calculates future repair period and future repair cost for each constituent, based on the deterioration state parameter; and
an output unit which outputs the calculation results of said calculation unit at least in a tabular format.

2. The computer program according to claim 1, wherein said output unit outputs the calculation results in a graphic format.

3. The computer program according to claim 1, wherein the repair cost is guaranteed by a building management company as the upper limit of the actual repair cost to be actually paid by the building owner.

4. A computer program for making a computer realize the functions of:
an input unit which inputs at least one deterioration state parameter that quantitatively represents a deterioration state of constituents of a building;
a calculation unit which calculates future management cost for each management job of the building, based on the deterioration state parameter; and
an output unit which outputs the calculation results of said calculation unit at least in a tabular format.

5. A computer program for making a computer realize the functions of:
a collecting unit which collects at least light and fuel expenses data for each tenant of a building in a predetermined cycle;
a calculation unit which calculates variable expenses for each tenant, based on the light and fuel expenses data; and
a bill issuing unit which issues a bill describing an amount billed including at least variable expenses for each tenant.

6. A computer program for making a computer realize the functions of:
an input unit which inputs at least one deterioration state parameter that quantitatively represents a deterioration state of constituents of a building;
a first calculation unit which calculates future repair period and future repair cost for each constituent, based on the deterioration state parameter;
a first output unit which outputs the calculation results of said first calculation unit at least in a tabular format;
a second calculation unit which calculates future management cost for each management job of the building, based on the deterioration state parameter; and
a second output unit which outputs the calculation results of said second calculation unit at least in a tabular format.

7. A computer program for making a computer realize the functions of:
an input unit which inputs at least one deterioration state parameter that quantitatively represents a deterioration state of constituents of a building;
a first calculation unit which calculates future repair period and future repair cost for each constituent, based on the deterioration state parameter;
a first output unit which outputs the calculation results of said first calculation unit at least in a tabular format;
a second calculation unit which calculates future management cost for each management job of the building, based on the deterioration state parameter;
a second output unit which outputs the calculation results of said second calculation unit at least in a tabular format;
a collecting unit which collects at least light and fuel expenses data for each tenant of a building in a predetermined cycle;
a third calculation unit which calculates variable expenses for each tenant,based on the light and fuel expenses data; and
a bill issuing unit which issues a bill describing an amount billed including at least variable expenses for each tenant.

8. A method of building management comprising the steps of:
inputting at least one deterioration state parameter that quantitatively represents a deterioration state of constituents of a building;
calculating future repair period and future repair cost for each constituent, based on the deterioration state parameter; and
outputting the calculation results at least in a tabular format.

9. The method according to claim 8, wherein in the output step, the calculation results are output in a graphic format.

10. The method according to claim 8, wherein the repair cost is guaranteed by a building management company as the upper limit of the actual repair cost to be actually paid by the building owner.

11. A method of building management comprising the steps of:
inputting at least one deterioration state parameter that quantitatively represents a deterioration state of constituents of a building;
calculating future management cost for each management job of the building, based on the deterioration state parameter; and
outputting the calculation results at least in a tabular format.

12. A method of building management comprising the steps of:
collecting at least light and fuel expenses data for each tenant of a building in a predetermined cycle;
calculating variable expenses for each tenant, based on the light and fuel expenses data; and
issuing a bill describing an amount billed including at least variable expenses for each tenant.

13. A method of building management comprising the steps of:
inputting at least one deterioration state parameter that quantitatively represents a deterioration state of constituents of a building;
calculating future repair period and future repair cost for each constituent, based on the deterioration state parameter and outputting the calculation results at least in a tabular format; and
calculating future management cost for each management job of the building, based on the deterioration state parameter and outputting the calculation results at least in a tabular format.

14. A method of building management comprising the steps of:
inputting at least one deterioration state parameter that quantitatively represents a deterioration state of constituents of a building;
calculating future repair period and future repair cost for each constituent, based on the deterioration state parameter and outputting the calculation results at least in a tabular format;
calculating future management cost for each management job of the building, based on the deterioration state parameter and outputting the calculation results at least in a tabular format;
collecting at least light and fuel expenses data for each tenant of a building in a predetermined cycle; and
calculating variable expenses for each tenant, based on the light and fuel expenses data and issuing a bill describing an amount billed including at least the variable expenses for each tenant.

15. An apparatus for building management comprising:
an input unit which inputs at least one deterioration state parameter that quantitatively represents a deterioration state of constituents of a building;
a calculation unit which calculates future repair period and future repair cost for each constituent, based on the deterioration state parameter; and
an output unit which outputs the calculation results of said calculation unit at least in a tabular format.

16. The apparatus according to claim 15, wherein said output unit outputs the calculation results in a graphic format.

17. The apparatus according to claim 15, wherein the repair cost is guaranteed by a building management company as the upper limit of the actual repair cost to be actually paid by the building owner.

18. An apparatus for building management comprising:
an input unit which inputs at least one deterioration state parameter that quantitatively represents a deterioration state of constituents of a building;
a calculation unit which calculates future management cost for each management job of the building, based on the deterioration state parameter; and
an output unit which outputs the calculation results of said calculation unit at least in a tabular format.

19. An apparatus for building management comprising:
a collecting unit which collects at least light and fuel expenses data for each tenant of a building in a predetermined cycle;
a calculation unit which calculates variable expenses for each tenant, based on the light and fuel expenses data; and
a bill issuing unit which issues a bill describing an amount billed including at least variable expenses for each tenant.

20. An apparatus for building management comprising:
an input unit which inputs at least one deterioration state parameter that quantitatively represents a deterioration state of constituents of a building;
a first calculation unit which calculates future repair period and future repair cost for each constituent, based on the deterioration state parameter;
a first output unit which outputs the calculation results of said first calculation unit at least in a tabular format;
a second calculation unit which calculates future management cost for each management job of the building, based on the deterioration state parameter; and
a second output unit which outputs the calculation results of said second calculation unit at least in a tabular format.

21. An apparatus for building management comprising:
an input unit which inputs at least one deterioration state parameter that quantitatively represents a deterioration state of constituents of a building;
a first calculation unit which calculates future repair period and future repair cost for each constituent, based on the deterioration state parameter;
a first output unit which outputs the calculation results of said first calculation unit at least in a tabular format;
a second calculation unit which calculates future management cost for each management job of the building, based on the deterioration state parameter;
a second output unit which outputs the calculation results of said second calculation unit at least in a tabular format;
a collecting unit which collects at least light and fuel expenses data for each tenant of a building in a predetermined cycle;
a third calculation unit which calculates variable expenses for each tenant, based on the light and fuel expenses data; and
a bill issuing unit which issues a bill describing an amount billed including at least variable expenses for each tenant.
